(19) United States
(12) Patent Application Publication
(10) Pub. No.: US 2007/0294767 A1
(43) Pub. Date: Dec. 20, 2007

(54) Method and system for accurate detection and removal of pestware

(76) Inventors: Paul Piccard, Longmont, CO (US); Michael P. Green, Boulder, CO (US)

Correspondence Address: COOLEY GODWARD KRONISH LLP;ATTN: PATENT GROUP, Suite 1100, 777 - 6th Street, NW, WASHINGTON, DC, 20001, US

(21) Appl. No.: 11/471,201

(22) Filed: Jun. 20, 2006

(51) Int. Cl. G06F 12/14

(52) U.S. Cl. 726/24

(57) ABSTRACT

A method and system for accurate detection and removal of pestware is described. One embodiment identifies a first indicator, the first indicator being associated with both a particular type of pestware and with at least one non-pestware software application; searches the computer for at least one additional indicator that the particular type of pestware is present on the computer; and confirms detection of the particular type of pestware on the computer when the at least one additional indicator is found.

### RELATED APPLICATIONS

The present application is related to the following commonly owned and assigned applications: U.S. application Ser. No. 10/956,573, Attorney Docket No. WEBR-003/00US, entitled “System and Method for Heuristic Analysis to Identify Pestware”; U.S. application Ser. No. 11/237,291, Attorney Docket No. WEBR-020/00US, entitled “Client Side Exploit Tracking”; and U.S. application Ser. No. 11/258,536, Attorney Docket No. WEBR-026/00US, entitled “System and Method for Reducing False Positive Indications of Pestware”; all of which are incorporated herein by reference.

### FIELD OF THE INVENTION

The present invention relates generally to the detection of pestware or malware on computers and to the removal of such pestware or malware. In particular, but not by way of limitation, the present invention relates to techniques for improving the accuracy of pestware detection and removal.

### BACKGROUND OF THE INVENTION

Protecting personal computers against a never-ending onslaught of “pestware” such as viruses, Trojan horses, spyware, adware, and downloaders on personal computers has become vitally important to computer users. Some pestware is merely annoying to the user or degrades system performance. Other pestware is highly malicious. Many computer users depend on anti-pestware software that attempts to detect and remove pestware automatically. Anti-pestware software typically scans running processes in memory and files contained on storage devices such as disk drives, comparing them, at expected locations, against a set of“signatures” that identify specific, known types of pestware.

Conventional anti-pestware software relies on a single, specific signature to identify a particular type of pestware. Once the particular type of pestware has been detected, the anti-pestware software may be capable, in some cases, of removing the components making up the particular type of pestware. A problem arises, however, when a known component of a particular type of pestware is found but that component alone is insufficient to justify the conclusion that the particular type of pestware is present on the computer. For example, the particular type of pestware may have one or more components in common with legitimate non-pestware applications. In such a case, the anti-pestware software may generate a false positive; erroneously delete components used by the legitimate non-pestware applications, causing them to malfunction; or both.

One example of such a situation is illustrated in FIG. 1. In FIG. 1, the components making up non-pestware application 105 and pestware 110 are diagrammed side by side. Non-pestware application 105 includes registry entry 115, executable file 120, common component 125, and dynamic link library (DLL) 130. Pestware 110 includes registry entry 135, executable file 140, common component 125, and signature 145 (e.g., a specific program instruction segment, string, or other identifying characteristic within pestware 110). As indicated by the arrow in FIG. 1, non-pestware application 105 and pestware 110 both use common component 125. One example of such a common component is Microsoft Corporation's .NET FRAMEWORK. Detecting the presence of a common component 125 such as the .NET FRAMEWORK is thus a necessary but not a sufficient condition for concluding that pestware 110 is present on a computer.

It is thus apparent that there is a need in the art for an improved method and system for accurate detection and removal of pestware.

### SUMMARY OF THE INVENTION

Illustrative embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents and alternative constructions that fall within the spirit and scope of the invention as expressed in the claims.

The present invention can provide a method and system for accurate detection and removal of pestware. One illustrative embodiment is a method for detecting pestware on a computer, comprising identifying a first indicator on a computer, the first indicator being associated with both a particular type of pestware and with at least one non-pestware software application; searching the computer for at least one additional indicator that the particular type of pestware is present on the computer; and confirming detection of the particular type of pestware on the computer when the at least one additional indicator is found.

Another illustrative embodiment is a system for detecting pestware on a computer, comprising a scanning module configured to identify a first indicator on the computer, the first indicator being associated with a particular type of pestware, the first indicator being insufficient by itself to warrant a conclusion that the particular type of pestware is present on the computer; and a confirmation module configured to search the computer for at least one additional indicator that the particular type of pestware is present on the computer, when the scanning module has identified the first indicator, and configured to confirm detection of the particular type of pestware on the computer when the at least one additional indicator is found. These and other embodiments are described in greater detail herein.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings wherein:

FIG. 1 is a diagram of a non-pestware application and pestware that share a common component;

FIG. 2 is a functional block diagram of a computer equipped with an anti-pestware system, in accordance with an illustrative embodiment of the invention;

FIG. 3 is a flowchart of a method for detecting pestware on a computer, in accordance with an illustrative embodiment of the invention.

FIGS. 4A and 4B are a flowchart of a method for detecting pestware on a computer, in accordance with another illustrative embodiment of the invention.

### DETAILED DESCRIPTION

“Pestware,” as used herein, refers to any program that damages or disrupts a computer system or that collects or reports information about a person or an organization. Examples include, without limitation, viruses, worms, Trojan horses, spyware, adware, and downloaders. A “non-pestware application,” as used herein, is any software application that is not pestware.

In an illustrative embodiment, an initial indicator is identified on a computer, the initial indicator being associated with both a particular type of pestware and with at least one non-pestware application. An indicator may be, for example, a registry entry, an installation directory, an executable file, a dynamic link library (DLL), a common software component, a specific pestware signature, or other identifying characteristic. Once the initial indicator has been identified, the computer is searched for other known indicators that the particular type of pestware is present on the computer. If sufficient additional indicators are found, detection of the particular type of pestware is confirmed. In confirming detection of the particular type of pestware, relative weighting factors may optionally be assigned to the various indicators. For example, an executable file may be weighted more heavily than a registry entry without an associated executable file. Optionally, a user may be notified of the presence of the detected pestware.

Once detection of the particular type of pestware has been confirmed, the components constituting the pestware can be removed from the computer. If the pestware includes a common component (e.g., the .NET FRAMEWORK mentioned in Background of the Invention) that is known to be used by one or more non-pestware applications, the presence of one or more such non-pestware applications can be confirmed, and the common component can be exempted from the removal process to prevent damage to legitimate software applications.

The embodiment just described provides at least two significant advantages over conventional anti-pestware systems: (1) reduction of false positives (incidences of falsely declaring pestware to be present when, in fact, it is not) and (2) improved accuracy in removing pestware without damaging non-pestware applications.

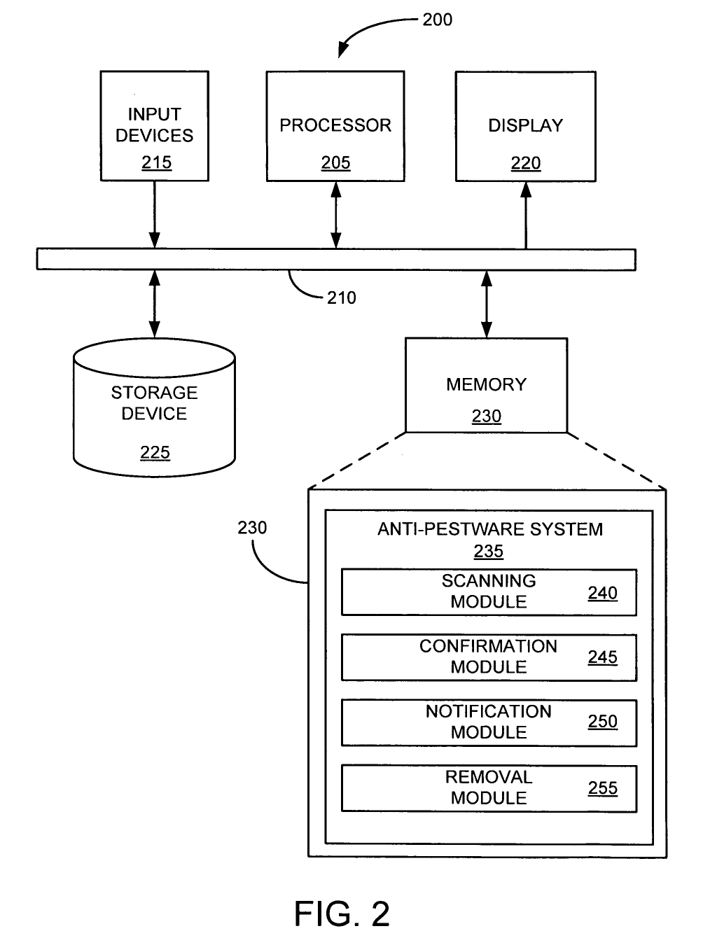

Referring now to the remaining drawings, where like or similar elements are designated with identical reference numerals throughout the several views, and referring in particular to FIG. 2, it is a functional block diagram of a computer 200 equipped with an anti-pestware system, in accordance with an illustrative embodiment of the invention. Computer 200 can be a desktop computer, workstation, laptop computer, notebook computer, handheld computer, or any other device that includes computing functionality. In FIG. 2, processor 205 communicates over data bus 210 with input devices 215, display 220, storage device 225, and memory 230.

Input devices 215 may be, for example, a keyboard and a mouse or other pointing device. In one illustrative embodiment, storage device 225 is a magnetic-disk device such as a hard disk drive (HDD) that stores directories (or folders) and files. In other embodiments, however, storage device 225 can be any type of computer storage device (“drive”), including, without limitation, a magnetic-disk drive, an optical-disc drive, and a storage device employing flash-memory-based media such as secure digital (SD) cards or multi-media cards (MMCs). Memory 230 may include random-access memory (RAM), read-only memory (ROM), or a combination thereof.

Memory 230 includes anti-pestware system 235. For convenience in this Detailed Description, the functionality of anti-pestware system 235 has been divided into four modules: scanning module 240, confirmation module 245, notification module 250, and removal module 255. In various embodiments of the invention, the functionality of these modules can be combined or subdivided in ways other than that indicated in FIG. 2. Also, notification module 250 and removal module 255 may be omitted in some embodiments.

In the illustrative embodiment of FIG. 2, anti-pestware system 235 is an application program stored on a computer-readable storage medium (e.g., storage device 225) of computer 200 that can be loaded into memory 230 and executed by processor 205. In general, the computer-readable storage medium can be, without limitation, a magnetic, optical, or solid-state storage medium. In other embodiments, the functionality of file deletion engine 235 can be implemented in software, firmware, hardware, or any combination thereof.

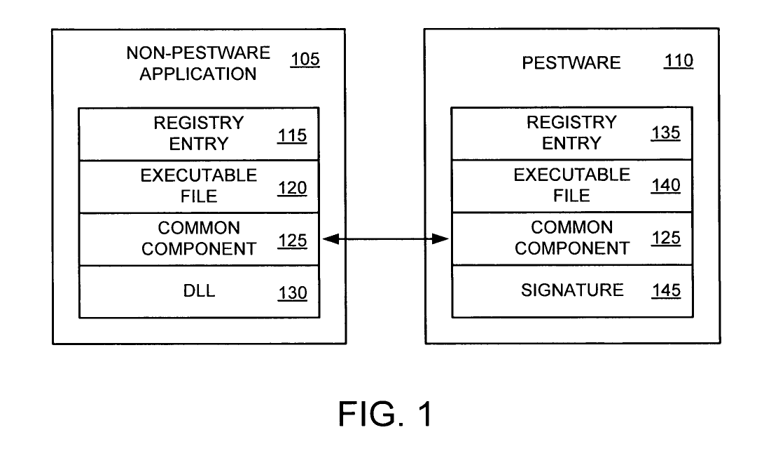

Scanning module 240 is configured to scan computer 200 for components identifying various types of pestware. In particular, scanning module 240 is configured to identify an initial indicator that a particular type of pestware is present on computer 200. Scanning module 240 has access, in a lookup table or database stored on computer 200, to the identifying characteristics of a wide variety of specific types of pestware. In some cases, the initial indicator may be sufficient to warrant a conclusion that a particular type of pestware is present on computer 200 (e.g., an executable file associated with the particular type of pestware is found on computer 200). In other situations, such as that shown in FIG. 1, the initial indicator is insufficient by itself to warrant such a conclusion. This situation can arise, for example, where the initial indicator is a component (e.g., a registry entry or the .NET FRAMEWORK mentioned above) that the particular type of pestware and one or more non-pestware applications are known to have in common.

Confirmation module 245 is configured to search computer 200 for additional indicators that the particular type of pestware is present for which scanning module 240 has found an initial indicator. Referring again to the example of FIG. 1, a particular type of pestware 110 may have an associated registry entry 135, an executable file 140, a common component 125, and a signature 145. If scanning module 240 were to find common component 125 first, that initial indicator would be insufficient to warrant a conclusion that the particular type of pestware 110 is present on computer 200. Confirmation module 245, in this example, searches computer 200 for the other known components of the particular type of pestware 110. If found, confirmation module 245 confirms detection of the particular type of pestware 110 on computer 200.

Optionally, confirmation module 245 may be configured to assign relative weighting factors to the various indicators that a particular type of pestware is present on computer 200. In confirming detection of a particular type of pestware on computer 200, confirmation module 245 may, for example, make use of such weighting factors and Boolean logic, either separately or in combination.

Notification module 250, an optional component of anti-pestware system 235, is configured to notify a user that detection of a particular type of pestware has been confirmed by confirmation module 245.

Removal module 255 is configured to remove from computer 200 pestware that confirmation module 245 has confirmed is present. Where the pestware does not share any common components with non-pestware applications, removal module 255 simply deletes all of the known components associated with the particular type of pestware. Where the pestware and one or more non-pestware applications share a common component, however, removal module 255 does not remove the common component, thereby ensuring that non-pestware applications that depend on the common component are not rendered inoperable. The remaining components of the pestware can be removed safely. In some embodiments, removal module 255 is further configured to confirm that the one or more non-pestware applications that are known to use a particular common component are in fact installed on computer 200. If so, removal module 255 exempts the common component from the removal process to prevent damage to legitimate applications.

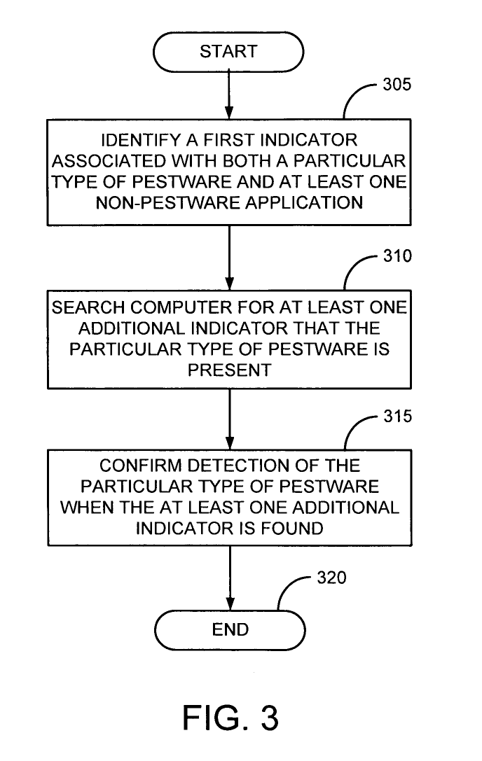

FIG. 3 is a flowchart of a method for detecting pestware on a computer, in accordance with an illustrative embodiment of the invention. At 305, scanning module 240 identifies, on computer 200, a first indicator associated with both a particular type of pestware and with at least one non-pestware application. Examples of such indicators were given above. At 310, confirmation module 245 searches computer 200 for at least one additional indicator that the particular type of pestware is present on computer 200. If sufficient additional indicators are found at 310 (in general, at least one such additional indicator), confirmation module 245, at 315, confirms detection of the particular type of pestware on computer 200. The process terminates at 320.

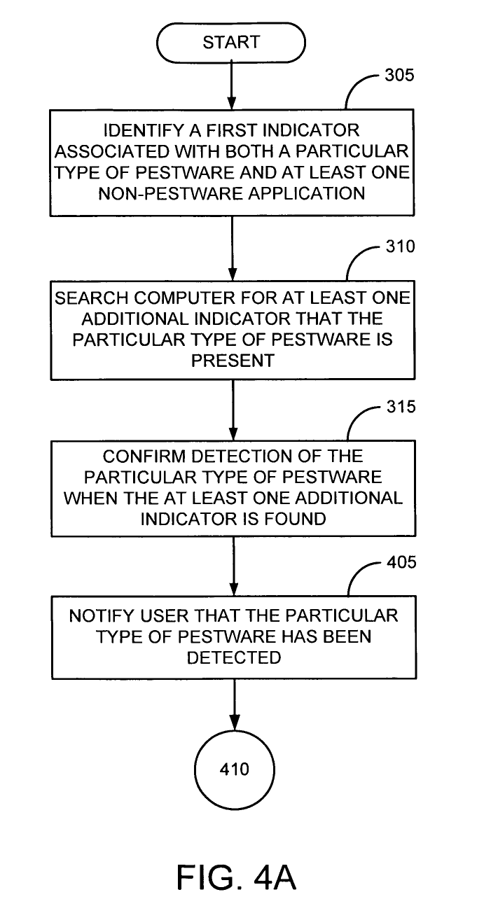

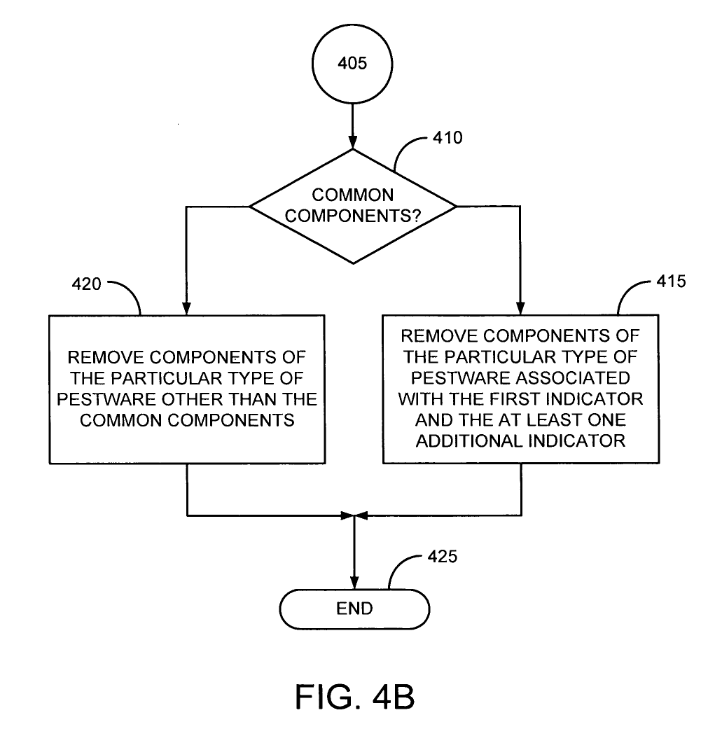

FIGS. 4A and 4B are a flowchart of a method for detecting pestware on a computer 200, in accordance with another illustrative embodiment of the invention. Referring first to FIG. 4A, Blocks 305, 310, and 315 are carried out as in FIG. 3. At 405, notification module 250 notifies a user that the particular type of pestware has been detected on computer 200. The process then proceeds to Block 410 in FIG. 4B.

If the particular type of pestware detected at 315 is known to have components in common with one or more non-pestware applications at 410, removal module 255 removes from computer 200, at 420, the components of the particular type of pestware other than the common components. Optionally, confirmation module 245 may search computer 200 to confirm that one or more non-pestware applications that depend on the common component are indeed installed on computer 200. Removal module 255 can use this information in determining whether to delete a given common component at 420.

If there are no common components at 410, removal module 255 deletes the components constituting the particular type of pestware at 415. At 425, the process terminates.

In conclusion, the present invention provides, among other things, a method and system for accurate detection and removal of pestware. Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims. For example, the .NET FRAMEWORK mentioned as an example of a common component is associated with operating systems sold by Microsoft Corporation under the trade name WINDOWS (e.g., WINDOWS XP). The invention is not limited to the environment of a WINDOWS operating system, however. Those skilled in the art will recognize that the principles of the invention can be applied to other operating systems such as the operating system sold under the trade name LINUX.

What is claimed is:

1. A method for detecting pestware on a computer, the method comprising:
identifying a first indicator on the computer, the first indicator being associated with both a particular type of pestware and with at least one non-pestware software application;
searching the computer for at least one additional indicator that the particular type of pestware is present on the computer; and
confirming detection of the particular type of pestware on the computer when the at least one additional indicator is found.

2. The method of claim 1, further comprising:
notifying a user that the particular type of pestware has been detected on the computer.

3. The method of claim 1, wherein the first indicator is associated with a component that is shared by the particular type of pestware and the at least one non-pestware software application.

4. The method of claim 1, further comprising:
removing from the computer components of the particular type of pestware associated with the first indicator and the at least one additional indicator when detection of the particular type of pestware has been confirmed.

5. The method of claim 4, wherein a component associated with the first indicator is not removed when the component associated with the first indicator is shared by the particular type of pestware and the at least one non-pestware application and a search of the computer has confirmed that the at least one non-pestware application is installed on the computer.

6. The method of claim 1, wherein the confirming includes assigning relative weighting factors to the first indicator and to each of the at least one additional indicator.

7. The method of claim 1, wherein an indicator is one of a registry entry, an installation directory, an executable file, a dynamic link library (DLL), and a software component.

8. A system for detecting pestware on a computer, the system comprising:
a scanning module configured to identify a first indicator on the computer, the first indicator being associated with a particular type of pestware, the first indicator being insufficient by itself to warrant a conclusion that the particular type of pestware is present on the computer; and
a confirmation module configured to:
search the computer for at least one additional indicator that the particular type of pestware is present on the computer when the scanning module has identified the first indicator; and
confirm detection of the particular type of pestware on the computer when the at least one additional indicator is found.

9. The system of claim 8, further comprising:
a notification module configured to notify a user that the particular type of pestware has been detected on the computer.

10. The system of claim 8, wherein the first indicator is associated with both the particular type of pestware and with at least one non-pestware software application.

11. The system of claim 10, wherein the first indicator is associated with a common component that is shared by the particular type of pestware and the at least one non-pestware software application.

12. The system of claim 8, further comprising:
a removal module configured to remove from the computer components of the particular type of pestware associated with the first indicator and the at least one additional indicator when the confirmation module has confirmed detection of the particular type of pestware.

13. The system of claim 12, wherein the removal module is configured not to remove a component associated with the first indicator when the component associated with the first indicator is shared by the particular type of pestware and at least one non-pestware application and the confirmation module has determined that the at least one non-pestware application is installed on the computer.

14. The system of claim 8, wherein the confirmation module is further configured to assign relative weighting factors to the first indicator and to each of the at least one additional indicator.

15. The system of claim 8, wherein an indicator is one of a registry entry, an installation directory, an executable file, a dynamic link library (DLL), and a software component.

16. A system for detecting pestware on a computer, the system comprising:
means for identifying a first indicator on the computer, the first indicator being associated with a particular type of pestware, the first indicator being insufficient by itself to warrant a conclusion that the particular type of pestware is present on the computer;
means for searching the computer for at least one additional indicator that the particular type of pestware is present on the computer; and
means for confirming detection of the particular type of pestware on the computer when the at least one additional indicator is found.

17. The system of claim 16, wherein the first indicator is associated with both the particular type of pestware and with at least one non-pestware software application.

18. The system of claim 16, further comprising:
means for notifying a user that the particular type of pestware has been detected on the computer.

19. The system of claim 16, further comprising:
means for removing from the computer components of the particular type of pestware associated with the first indicator and the at least one additional indicator when detection of the particular type of pestware has been confirmed.

20. The system of claim 19, wherein the means for removing is configured not to remove a component associated with the first indicator when the component associated with the first indicator is shared by the particular type of pestware and at least one non-pestware application and the means for confirming has determined that the at least one non-pestware application is installed on the computer.

21. A computer-readable storage medium having program instructions executable by a processor to detect pestware on a computer, the program instructions comprising:
a first code segment configured to identify a first indicator on the computer, the first indicator being associated with both a particular type of pestware and with at least one non-pestware software application;
a second code segment configured to search the computer for at least one additional indicator that the particular type of pestware is present on the computer; and
a third code segment configured to confirm detection of the particular type of pestware on the computer when the at least one additional indicator is found.
